(19) United States
(12) Patent Application Publication
(10) Pub. No.: US 2023/0148114 A1
(43) Pub. Date: May 11, 2023

(54) PARKING ASSIST APPARATUS

(71) Applicant: TOYOTA JIDOSHA KABUSHIKI KAISHA, Toyota-shi (JP)

(72) Inventor: Yu HIEI, Chiryu-shi (JP)

(73) Assignee: TOYOTA JIDOSHA KABUSHIKI KAISHA, Toyota-shi (JP)

(21) Appl. No.: 18/049,097

(22) Filed: Oct. 24, 2022

(30) Foreign Application Priority Data
Nov. 11, 2021 (JP) 2021-184029

(51) Int. Cl. B60W 30/06; B60W 50/14; G06V 20/58; G06T 7/70; B60R 1/22; B60L 53/66; B60L 53/126; H04W 4/44

(52) U.S. Cl. CPC B60W 30/06; B60W 50/14; G06V 20/586; G06T 7/70; B60R 1/22; B60L 53/66; B60L 53/126; H04W 4/44; B60W 2050/146; B60W 2540/215; B60W 2556/45; G06T 2207/30264; B60R 2300/806; B60L 2250/16

(57) ABSTRACT

An external appearance image of a power transmission unit of a wireless power supply device is registered in a parking assist apparatus in association with identification information on the wireless power supply device. The parking assist apparatus superimposes and displays a target parking area image on a parking space image showing a parking space, and superimposes and displays the external appearance image associated with identification information having the same content as the identification information acquired from the wireless power supply device by wireless communication at a position corresponding to an installation position of the power transmission unit on the parking space image.

### BACKGROUND OF THE INVENTION

### 1. Field of the Invention

The present invention relates to a parking assist apparatus capable of charging a vehicle battery by receiving power from a power supply device arranged externally to a vehicle.

### 2. Description of the Related Art

Hitherto, there has been known a vehicle including a power receiving unit which can receive power from a power transmission unit of a power supply device installed in a parking space, and which is configured to be able to charge a battery with the power transmitted from the power transmission unit to the power receiving unit. When such a vehicle is parked in the parking space in which the power transmission unit is installed, it is preferred that the vehicle stop at a position suitable for charging, specifically, stop at a position at which the position of the power transmission unit installed in the parking space and the position of the power receiving unit of the vehicle match each other in a top view.

In Japanese Patent Application Laid-open No. 2017-138664 and WO 2011/132271 A1, there is disclosed a parking assist apparatus which assists parking of a vehicle in a position suitable for charging. Specifically, the parking assist apparatus as described in Japanese Patent Application Laid-open No. 2017-138664 is configured to photograph the parking space and a road surface in the vicinity of the parking space by using a camera mounted on the vehicle, and detect a target parking position by converting coordinates (coordinates of pixels) in the image of an image of the power transmission unit included in the taken images to coordinates in real space. The parking assist apparatus as described in WO 2011/132271 A1 is configured to photograph a light emitting portion arranged in a power transmission unit by using a camera, detect the position and orientation of the light emitting portion by using image recognition, calculate a positional relationship between the power transmission unit and the vehicle based on results of the detection, and guide the vehicle to a position suitable for charging by controlling the steering of the vehicle based on a result of the calculation of the positional relationship between the power transmission unit and the vehicle.

Further, hitherto, there has been known a parking assist apparatus configured so that an occupant of a vehicle can set a target parking area of the vehicle. Such a parking assist apparatus displays an image showing a parking space present in the vicinity of the vehicle (in other words, an image showing the landscape of a peripheral region of the vehicle) on a display device, and superimposes and displays an image showing the target parking area of the vehicle on the image showing the parking space. The occupant of the vehicle can set the position of the target parking area of the vehicle by performing an operation of moving the image showing the target parking area on the image showing the landscape of the peripheral region of the vehicle.

Incidentally, the dimensions and shape of the power transmission unit may vary from manufacturer to manufacturer. Further, the installation position of the power transmission unit in the parking space may differ depending on the parking space. Therefore, until now, it has not been easy to set the target parking area to a position suitable for charging in accordance with the dimensions, shape, and installation position of the power transmission unit.

### SUMMARY OF THE INVENTION

The present invention has been made in order to address the problem described above. That is, an object of the present invention is to provide a parking assist apparatus capable of setting a target parking area to a position suitable for charging in accordance with dimensions, shape, and installation position of a power transmission unit installed in a parking space.

According to at least one embodiment of the present invention, there is provided a parking assist apparatus (20), the parking assist apparatus (20) being mounted on a vehicle (10) including a power receiving unit (224) configured to receive power from a power supply device (90) including a power transmission unit (92), the parking assist apparatus (20) being configured to execute parking assist for parking the vehicle (10) in a parking space, the parking assist apparatus (20) including: a wireless communication device (223) configured to perform wireless communication to and from the power supply device (90); an image pickup device (210, 211, 212, 213) configured to photograph a peripheral region of the vehicle (10); a display device (208) configured to display an image taken by the image pickup device (210, 211, 212, 213); and a control device (201) configured to search for a parking space present in the peripheral region of the vehicle (10) from the image of the peripheral region of the vehicle (10) taken by the image pickup device (210, 211, 212, 213), set a target parking area in the parking space detected by the search, and assist parking of the vehicle (10) in the target parking area. The control device (201) has an external appearance image showing an external appearance of each of a plurality of the power transmission units (92) registered therein in association with identification information on the power supply device (90). The control device (201) is configured to: display a parking space image showing the detected parking space on the display device (208); superimpose and display, on the parking space image, a target parking area image (306) showing a target parking area of the vehicle (10) with respect to the parking space and a position of the power receiving unit (224) when the vehicle (10) is parked in the target parking area; identify an installation position of the power transmission unit (92) in the parking space based on the image taken by the image pickup device (210, 211, 212, 213); acquire the identification information from the power supply device (90) via the wireless communication device (223); and superimpose and display the external appearance image associated with the identification information acquired from the power supply device (90) on a position corresponding to the installation position in the parking space image displayed on the display device (208).

According to the at least one embodiment of the present invention, the positional relationship between the power transmission unit installed in the parking space and the power receiving unit of the vehicle when the vehicle is parked in the target parking area can be grasped from the target parking area image and the external appearance image of the power transmission unit superimposed and displayed by the display device. Therefore, the target parking area can be set to a position suitable for charging in accordance with the position of the power transmission unit. Further, the external appearance image of the power transmission unit is displayed on the display device, and hence the target parking area can be set to a position more suitable for charging in accordance with the shape of the external appearance of the power transmission unit.

In one aspect of the present invention, the control device (201) may be configured to control display of the target parking area image (306) so that the target parking area image (306) displayed on the display device (208) is movable.

With the above-mentioned configuration, through the movement of the target parking area image, the installation position of the power transmission unit installed in the parking space and the position of the power receiving unit of the vehicle parked in the target parking area can be aligned within the parking space image displayed on the display device.

In one aspect of the present invention, the control device (201) may be configured to display, on the display device (208), a movement button image (303) for moving the target parking area image (306).

With the above-mentioned configuration, the user can easily move the target parking area image by operating the movement button image displayed on the display device.

In one aspect of the present invention, the identification information may be information indicating a manufacturer of the power supply device (90).

With the above-mentioned configuration, when the external shape (external appearance) of the power transmission unit is different for each manufacturer, an appropriate external appearance image (external appearance image showing the power transmission unit installed in the parking space) can be displayed in accordance with the manufacturer of the power transmission unit.

In one aspect of the present invention, the control device (201) may have an external appearance image (305) showing an external appearance shape of each of a plurality of the power transmission units (92) registered therein in advance in association with the identification information, and the control device (201) may be configured to superimpose and display the external appearance image (305) registered in association with the identification information acquired from the power supply device (90) on a position corresponding to the installation position in the parking space image (302) displayed on the display device (208).

With the above-mentioned configuration, the external appearance image can be displayed on the display device by reading out the external appearance image associated with the identification information from among the plurality of external appearance images registered in advance.

In one aspect of the present invention, the power receiving unit (224) may include a power receiving coil (225) configured to receive transmission of power in a non-contact manner from the power transmission unit (92) including a power transmission coil (93).

In the method of transmitting power from the power transmission unit to the power receiving unit in a non-contact manner, when the misalignment between the power transmission coil of the power transmission unit and the power receiving coil of the power receiving unit becomes smaller, the efficiency of power transmission becomes higher. Therefore, with the above-mentioned configuration, the efficiency of power transmission from the power transmission unit of the power supply device to the power receiving unit of the vehicle can be increased.

In one aspect of the present invention, when an operation to instruct the vehicle (10) to be moved to the target parking area is detected, control to move the vehicle (10) to the target parking area may be started.

With the above-mentioned configuration, the user can park the vehicle in the position suitable for charging in the parking space (target parking area) by aligning the external appearance image of the power transmission unit with the power receiving unit in the parking space image displayed on the display device, and then performing the operation to instruct the vehicle to be moved to the target parking area (operation to start parking).

In the above description, the terms and/or reference symbols used in at least one embodiment described later are enclosed in parentheses and assigned to the components of the present invention corresponding to the at least one embodiment for easier understanding of the present invention. However, the constituent elements of the present invention are not limited to the at least one embodiment defined by the terms and/or reference symbols.

### BRIEF DESCRIPTION OF THE DRAWINGS

FIG. 1 is a diagram for illustrating a parking assist apparatus according to at least one embodiment of the present invention.

FIG. 2A is a diagram for illustrating an example of a setting image.

FIG. 2B is a diagram for illustrating an example of a parking space image.

FIG. 2C is a diagram for illustrating an example of a parking space image.

FIG. 3A is a flowchart for illustrating a parking assist routine to be executed by a CPU.

FIG. 3B is a flowchart for illustrating a parking assist routine to be executed by the CPU.

### DESCRIPTION OF THE EMBODIMENTS

At least one embodiment of the present invention is now described. In the following description, a parking assist apparatus for a vehicle may be abbreviated as “assist apparatus.” Further, “parking space” in the following description means a space partitioned so that one vehicle can park.

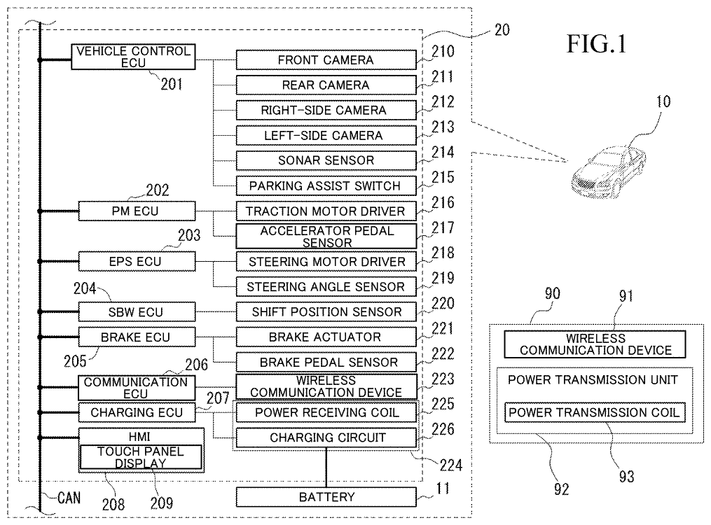

FIG. 1 is a diagram for illustrating a configuration example of a vehicle 10, an assist apparatus 20 mounted on the vehicle 10, and a wireless power supply device 90 that can transmit power (can transmit electrical power) to the vehicle 10 in a non-contact manner. The vehicle 10 is an electric vehicle (electric automobile), which includes a traction motor (not shown) and a battery 11. The traction motor is a driving force source for traveling. The battery 11 is a power source for in-vehicle devices including the traction motor. The assist apparatus 20 is configured such that power can be received (transmission of electrical power can be received) from the wireless power supply device 90 installed in a parking space PS in a non-contact manner to charge the battery 11.

The wireless power supply device 90 is configured to transmit power to the assist apparatus 20 in a non-contact manner. The wireless power supply device 90 includes a power transmission unit 92 including a power transmission coil 93, and a wireless communication device 91 capable of wireless communication to and from a wireless communication device 223 mounted on the vehicle 10. To distinguish between the wireless communication device 223 and the wireless communication device 91, the wireless communication device 223 mounted on the vehicle 10 is hereinafter referred to as “in-vehicle communication device 223,” and the wireless communication device 91 of the wireless power supply device 90 is referred to as “equipment communication device 91.” The power transmission unit 92 is installed at a predetermined position on a road surface of the parking space PS so that the power transmission unit 92 is located at a lower position than the vehicle 10 when the vehicle 10 is parked in the parking space PS. The configuration of the wireless power supply device 90 is not particularly limited, and a configuration publicly known in the related art can be applied.

As illustrated in FIG. 1, the assist apparatus 20 includes a vehicle control ECU 201, a power management ECU (hereinafter referred to as “PM ECU 202”), an electric power steering ECU (hereinafter referred to as “EPS ECU 203”), a shift-by-wire ECU (hereinafter referred to as “SBW ECU 204”), a brake ECU 205, a communication ECU 206, a charging ECU 207, and a human machine interface (HMI) 208. Each ECU includes a microcomputer. The microcomputer includes, for example, a CPU, a ROM, a RAM, a readable and writable non-volatile memory, and an interface. The CPU implements various functions by executing instructions (programs and routines) stored in the ROM. The ECUs and the HMI 208 are connected to each other so that data is exchangeable (communicable) via a controller area network (CAN). Therefore, detection results obtained by sensors connected to a certain ECU and operations to switches, for example, can be acquired by an ECU other than the certain ECU.

The vehicle control ECU 201 is a central electronic control unit which assists the driver with parking. The vehicle control ECU 201 is an example of a control device in the present invention, and executes parking assist control described later. A plurality of cameras 210, 211, 212, and 213, a plurality of sonar sensors 214, and a parking assist switch 215 are connected to the vehicle control ECU 201. In FIG. 1, one sonar sensor 214 is illustrated for simplification.

The plurality of cameras 210, 211, 212, and 213 are an example of an image pickup device in the present invention. The plurality of cameras 210, 211, 212, and 213 generate image data by photographing the landscape of the region around the vehicle 10 (the landscape outside the vehicle). The plurality of cameras 210, 211, 212, and 213 include a front camera 210, a rear camera 211, a right-side camera 212, and a left-side camera 213. The front camera 210 is arranged, for example, in a substantially central portion of a front bumper in a vehicle width direction, and generates image data by photographing a landscape including the road surface in front of the vehicle 10. The rear camera 211 is arranged, for example, on a wall portion of a rear trunk at the rear of the vehicle 10, and generates image data by photographing a landscape including the road surface behind the vehicle 10. The right-side camera 212 is arranged, for example, on a right side-view mirror, and generates image data by photographing a landscape including the road surface on the right side of the vehicle 10. The left-side camera 213 is arranged, for example, on a left side-view mirror, and generates image data by photographing a landscape including the road surface on the left side of the vehicle 10. Each of the cameras 210, 211, 212, and 213 transmits the generated image data to the vehicle control ECU 201.

Each sonar sensor 214 is a well-known sensor which uses ultrasonic waves. Each sonar sensor 214 emits ultrasonic waves in a predetermined range around the vehicle 10 and receives reflected waves reflected by an object. Each sonar sensor 214 detects the presence or absence of a three-dimensional object and the distance to the three-dimensional object based on a period of time from the transmission to the reception of the ultrasonic waves, and transmits the detection result to the vehicle control ECU 201.

The parking assist switch 215 is a switch which can be operated by an occupant of the vehicle 10 (user of the vehicle 10). The parking assist switch 215 is arranged at a position at which the occupant (driver) sitting in a driver's seat of the vehicle 10 can operate the parking assist switch 215. The vehicle control ECU 201 can detect an operation on the parking assist switch 215.

An image showing an external appearance of the power transmission unit 92 of each of a plurality of wireless power supply devices 90 is registered in the vehicle control ECU 201 in association with identification information on the wireless power supply device 90. For the identification information, information indicating a manufacturer of the wireless power supply device 90 is used. The “image showing the external appearance of the power transmission unit 92” is hereinafter referred to as “external appearance image 305,” and the data including the external appearance image 305 is hereinafter referred to as “external appearance data.” The external appearance image 305 is an image of the power transmission unit 92 taken from vertically above. The “external appearance image 305 is registered in the vehicle control ECU 201” can also be said to be “the external appearance data is stored in the non-volatile memory of the vehicle control ECU 201 in a computer-readable format.”

The vehicle control ECU 201 is configured such that additional external appearance images 305 can be registered. In other words, the occupant of the vehicle 10 can additionally store the external appearance data of the power transmission unit 92 of an unregistered wireless power supply device 90 in the readable/writable non-volatile memory of the vehicle control ECU 201. Further, when the in-vehicle communication device 223 is connected to the Internet, the vehicle control ECU 201 may access a server in which the external appearance data of the power transmission unit 92 of the wireless power supply device 90 is stored, and when the external appearance data of the power transmission unit 92 of the wireless power supply device 90 not registered in the vehicle control ECU 201 exists in the server, the vehicle control ECU 201 may download and store the external appearance data in the readable/writable non-volatile memory. In this case, it is required to prepare in advance a server in which the external appearance data of the power transmission unit 92 of the wireless power supply device 90 is stored.

In addition, a vehicle speed sensor (not shown) is connected to the vehicle control ECU 201. The vehicle speed sensor is configured to detect the vehicle speed and transmit a signal indicating the detected vehicle speed to the vehicle control ECU 201.

The PM ECU 202 is an electronic control unit for controlling a driving force generated by the traction motor. A traction motor driver 216 and an accelerator pedal sensor 217 are connected to the PM ECU 202. The traction motor driver 216 drives the traction motor. The traction motor driver 216 is, for example, an inverter. The accelerator pedal sensor 217 detects an operation amount of an accelerator pedal (not shown) and transmits the detection result to the PM ECU 202. The PM ECU 202 sets a target driving force in accordance with the operation amount of the accelerator pedal detected by the accelerator pedal sensor 217, and controls the traction motor driver 216 so that the target driving force is generated.

The vehicle control ECU 201 can transmit a drive command (a signal for controlling the driving force, for example, a signal indicating a target travel speed) to the PM ECU 202. When the PM ECU 202 receives the drive command from the vehicle control ECU 201, the PM ECU 202 controls the traction motor driver 216 so that the vehicle 10 travels at the travel speed indicated by the drive command. Therefore, the PM ECU 202 can automatically drive the traction motor (that is, without requiring the driver to operate the accelerator pedal) in accordance with the drive command received from the vehicle control ECU 201.

The EPS ECU 203 is an electronic control unit of a well-known electric power steering system. The EPS ECU 203 is connected to a steering motor driver 218 and a steering angle sensor 219. The steering motor driver 218 can change a steering angle (also referred to as “steered angle” or “steer angle”) of the vehicle 10 by controlling a steering motor (not shown). The steering angle sensor 219 is configured to detect the steering angle of a steering wheel of the vehicle 10, and output a signal indicating the steering angle. The EPS ECU 203 applies a steering torque (steering assist torque) to a steering mechanism (not shown) by controlling the steering motor driver 218 based on the signal output from the steering angle sensor 219 and the vehicle speed and driving the steering motor, thereby assisting the steering operation by the driver.

The vehicle control ECU 201 can transmit a steering command (a signal for controlling the steering angle of the vehicle 10, for example, a signal including a target steering angle) to the EPS ECU 203. When the EPS ECU 203 receives the steering command from the vehicle control ECU 201, the EPS ECU 203 controls the steering motor driver 218 in accordance with the received steering command. Therefore, the vehicle control ECU 201 can automatically change the steering angle of steered wheels of the vehicle 10 (that is, without requiring a steering operation by the driver) via the EPS ECU 203.

The SBW ECU 204 is connected to a shift position sensor 220. The shift position sensor 220 detects a position of a shift lever, which is an operating member that can be operated by the driver. The positions of the shift lever include a parking position (P), a forward drive position (D), and a reverse position (R). The SBW ECU 204 receives the position of the shift lever from the shift position sensor 220, and switches a shift range of a transmission (not shown) of the vehicle 10 based on the position (that is, performs shift control of the vehicle 10).

The vehicle control ECU 201 can transmit a shift change command to the SBW ECU 204. When the SBW ECU 204 receives the shift change command from the vehicle control ECU 201, the SBW ECU 204 performs control to switch the shift range of the transmission in accordance with the received shift change command. Therefore, the vehicle control ECU 201 can automatically change the shift range of the transmission of the vehicle 10 (that is, without requiring the driver to operate the shift lever) via the SBW ECU 204.

The brake ECU 205 is connected to a brake actuator 221 and a brake pedal sensor 222. The brake pedal sensor 222 is configured to detect an operation amount of a brake pedal (not shown). The brake ECU 205 applies to the wheels a braking force in accordance with the operation amount of the brake pedal by operating the brake actuator 221 in accordance with the detection result of the operation amount of the brake pedal acquired from the brake pedal sensor 222.

The vehicle control ECU 201 can transmit a braking command (a signal for controlling the braking force, for example, a signal including a target braking force) to the brake ECU 205. When the brake ECU 205 receives the braking command from the vehicle control ECU 201, the brake ECU 205 controls the brake actuator 221 in accordance with the received braking command. Therefore, the brake ECU 205 can automatically control the braking force of the vehicle 10 (that is, without requiring the driver to operate the brake pedal) by controlling the brake actuator 221.

The in-vehicle communication device 223 (wireless communication device) is connected to the communication ECU 206. The in-vehicle communication device 223 can perform wireless communication to and from the wireless communication device (equipment communication device 91) of the wireless power supply device 90. The in-vehicle communication device 223 and the equipment communication device 91 each include a communication circuit compliant with a wireless LAN standard or a wireless PAN standard, for example, the Institute of Electrical and Electronic Engineers (IEEE) 802.11 series or the IEEE 802.15 series. The in-vehicle communication device 223 and the equipment communication device 91 may each include a communication circuit compliant with a short-range wireless communication standard, such as dedicated short-range communications (DSRC) or radio frequency identifier (RFID). The in-vehicle communication device 223 and the equipment communication device 91 are configured to enable wireless communication to and from each other by at least two types of communication methods (communication standards) different from each other. For example, the in-vehicle communication device 223 and the equipment communication device 91 each include a plurality of communication circuits capable of wireless communication using different communication methods. Further, one of the in-vehicle communication device 223 and the equipment communication device 91 may include a tag (an information recording medium that reads and writes data in a non-contact manner by using radio waves (electromagnetic waves)), and the other may include a reader that reads out data from the tag in a non-contact manner. The in-vehicle communication device 223 performs wireless communication to and from the equipment communication device 91 under the control by the communication ECU 206. The communication ECU 206 transmits and receives various types of information to be used for a power receiving unit 224 to receive power from the wireless power supply device 90 in a non-contact manner by using the wireless communication to and from the wireless power supply device 90.

The charging ECU 207 controls the charging of the battery 11. The power receiving unit 224 is connected to the charging ECU 207. The power receiving unit 224 includes a power receiving coil 225 and a charging circuit 226. The power receiving coil 225 is configured to receive the supply of power from the power transmission coil 93 of the wireless power supply device 90 in a non-contact manner. The charging circuit 226 charges the battery 11 with the power received by the power receiving coil 225 under the control of the charging ECU 207. The power receiving coil 225 is installed on a bottom surface of a vehicle body (for example, a lower surface of a floor panel).

The HMI 208 is an example of a display device in the present invention. The HMI 208 is arranged at a place at which the driver of the vehicle 10 can see and operate the HMI 208. The HMI 208 includes a touch panel display 209 which can display images and receive touch operations. The vehicle control ECU 201 can display various images on the touch panel display 209 of the HMI 208 and can detect an operation on the touch panel display 209.

(Parking Assist Control)

Next, parking assist control to be executed by the assist apparatus 20 is described. The parking assist control is a control for assisting the parking of the vehicle 10 in a target parking area TA. The target parking area TA is an area in which the vehicle 10 is to be actually parked (area in which the vehicle 10 is to fit) in the parking space PS, and is an area having substantially the same shape and dimensions as those of the vehicle 10 in a top view. The parking assist control executed by the assist apparatus 20 includes control for assisting, for example, the driver of the vehicle 10 to set the target parking area TA to a “position suitable for charging,” and control for moving the vehicle 10 to the target parking area TA and stopping the vehicle 10 without requiring operation of the accelerator pedal, operation of the brake pedal, operation of the steering wheel by the driver of the vehicle 10.

The “position suitable for charging” is a position at which the position of the power transmission unit 92 installed in the parking space PS and the position of the power receiving unit 224 of the vehicle 10 match each other in a top view. More specifically, the “position suitable for charging” is a position at which the center of the power transmission coil 93 of the power transmission unit 92 and the center of the power receiving coil 225 of the power receiving unit 224 match each other in a top view. The reason for this is that, in a case in which power is transmitted in a non-contact manner from the wireless power supply device 90, the efficiency of power transmission becomes higher as the deviation between the position of the power transmission coil 93 of the wireless power supply device 90 installed in the parking space PS and the position of the power receiving coil 225 mounted on the vehicle 10 in a top view becomes smaller.

(Detection (Recognition) of Parking Space)

The vehicle control ECU 201 searches for the parking space PS present in the peripheral region of the vehicle 10 by using the image data acquired from each of the cameras 210, 211, 212, and 213. Specifically, the vehicle control ECU 201 extracts a plurality of feature points included in the image data acquired from each of the cameras 210, 211, 212, and 213. Each feature point is a minute region in which a change in brightness is equal to or more than a threshold value (in other words, a region in which the brightness changes abruptly). Further, the vehicle control ECU 201 acquires gradation information on areas including the detected feature points. Specifically, the vehicle control ECU 201 sets a square area having a predetermined length on each side centered on one acquired feature point as a feature area corresponding to the one feature point, and divides the set feature area into a plurality of divided areas (specifically, 25 squares arranged in a matrix of 5 rows by 5 columns). Then, the vehicle control ECU 201 acquires the brightness of each divided area, and calculates, for each divided area, a “difference from an average brightness (that is, an average value of the brightness of all the divided areas) (=(brightness of each divided area)-(average value of brightness of all divided areas).” The vehicle control ECU 201 acquires the calculated difference as gradation information indicating a trend in the level of the brightness in each feature area. The vehicle control ECU 201 stores information including the position information on each detected feature point and the gradation information on each feature area corresponding to each feature point in the non-volatile memory in association with ID information for identifying the feature point as information relating to each feature point (hereinafter referred to as “feature point information”). Then, the vehicle control ECU 201 converts the feature point information into coordinates in a real coordinate system (coordinate system indicating a position in real space based on a predetermined position of the vehicle 10 as a reference (coordinate origin)) by applying distortion correction to the coordinates of each feature point on the image (that is, the positions of the pixels corresponding to each feature point on the image).

When the vehicle control ECU 201 detects an operation on the parking assist switch 215, the vehicle control ECU 201 searches for the parking space PS by using the feature point information included in the image. For example, the vehicle control ECU 201 detects white lines drawn on the road surface by linearly approximating rows of feature points included in the image (that is, edges included in the image), and recognizes the region between two detected parallel white lines as the parking space PS. As the method of detecting (recognizing) the parking space PS, various publicly known methods can be applied. For example, the methods as described in Japanese Patent Application Laid-open No. 2007-290558 and Japanese Patent Application Laid-open No. 2008-201178 can be applied.

(Identification of Position of Power Transmission Unit)

The vehicle control ECU 201 searches for the power transmission unit 92 installed in the parking space PS by performing publicly known image recognition processing on the image data acquired from each of the cameras 210, 211, 212, and 213. Further, when the vehicle control ECU 201 detects the power transmission unit 92, the vehicle control ECU 201 identifies the position (coordinates in real coordinate system) of the power transmission unit 92.

There are power transmission units 92 which have a recognition marker (a predetermined figure which may be referred to as “alignment mark”). In this case, the vehicle control ECU 201 searches for the image of the marker included in the image data acquired from each of the cameras 210, 211, 212, and 213. Further, there are power transmission units 92 which have a plurality of light sources arranged in a predetermined arrangement. In this case, the vehicle control ECU 201 searches for a plurality of light-emitting light sources included in the image data acquired from each of the cameras 210, 211, 212, and 213. The vehicle control ECU 201 may also search for the power transmission unit 92 installed in the parking space PS by pattern matching. In this case, the external appearance image 305 described later may be used as a template image, and the image of the parking space PS taken by each of the cameras 210, 211, 212, and 213 may be used as a search image.

(Acquisition of Identification Information on Wireless Power Supply Device)

The vehicle control ECU 201 acquires identification information for identifying the power transmission unit 92 installed in the parking space PS from the wireless power supply device 90. Specifically, first, the communication ECU 206 continuously searches for the equipment communication device 91 of the wireless power supply device 90 capable of wireless communication present in the peripheral region of the vehicle 10 by using one of a plurality of communication methods (communication standards). For convenience of description, this communication method is referred to as “first communication method.” As the first communication method, for example, a communication method compliant with a wireless LAN standard such as the IEEE 802.11 series can be applied. When the communication ECU 206 detects a wireless power supply device 90 capable of wireless communication, the communication ECU 206 establishes wireless communication to and from the equipment communication device 91 of the wireless power supply device 90. When wireless communication based on the first communication method is established between the in-vehicle communication device 223 and the equipment communication device 91, the vehicle control ECU 201 acquires the identification information on the wireless power supply device 90 from the wireless power supply device 90 by wireless communication. The identification information can also be said to be information for identifying the external appearance (dimensions and shape) of the power transmission unit 92 installed in the parking space PS. In the at least one embodiment, as the identification information acquired from the wireless power supply device 90, information indicating the manufacturer (manufacturing company) of the wireless power supply device 90 installed in the parking space PS is used.

(Setting of Target Parking Area)

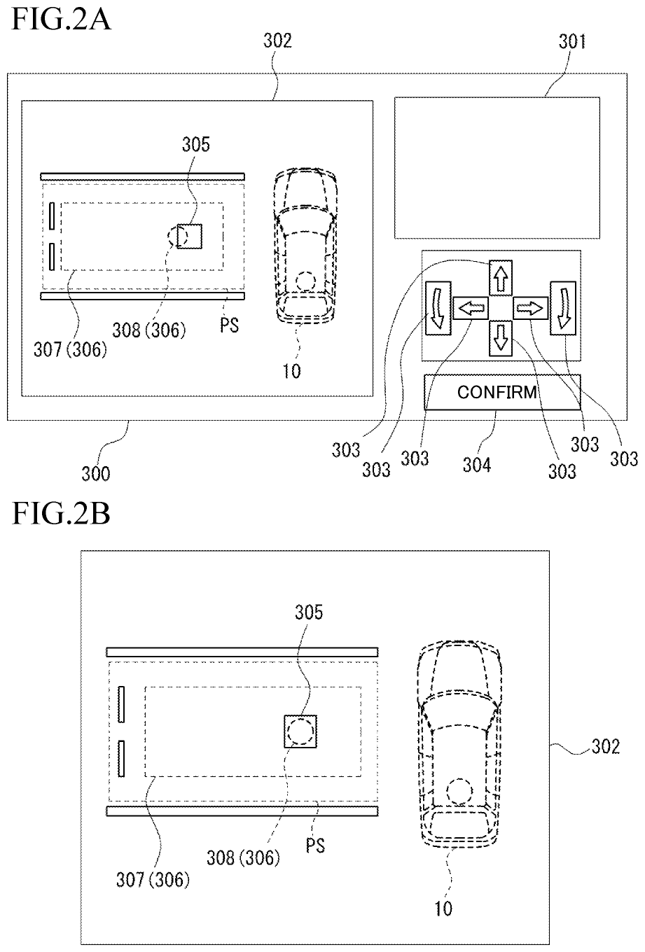

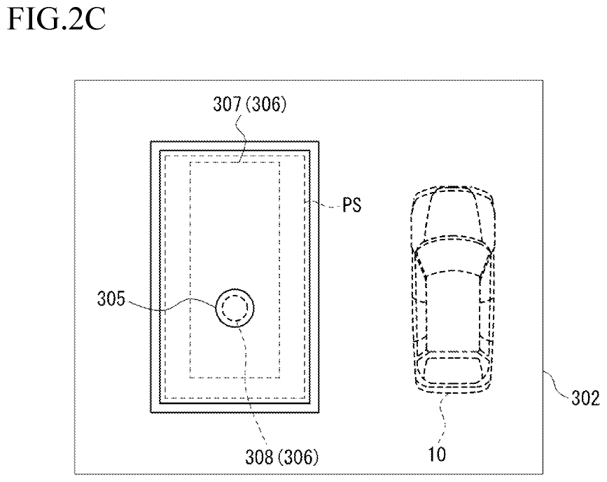

The vehicle control ECU 201 displays a setting image 300 on the touch panel display 209 of the HMI 208 so that the occupant of the vehicle 10 can set the position and orientation of the target parking area TA. FIG. 2A is a diagram for illustrating an example of the setting image 300. The setting image 300 includes a camera image 301, a parking space image 302, movement button images 303, and a confirmation button image 304. The camera image 301 is an image from the camera viewpoint of the parking space PS taken by each of the cameras 210, 211, 212, and 213 (the camera image 301 can also be said to be an image of the parking space PS as viewed from the vehicle 10). The parking space image 302 is an image of the peripheral region of the vehicle 10, and is an image of the landscape including the detected parking space PS as viewed from vertically above. FIG. 2B is a diagram for illustrating an example of the parking space image 302 of the parking space PS in which a power transmission unit 92 having a quadrilateral shape in a top view is installed. Further, FIG. 2C is a diagram for illustrating an example of the parking space image 302 of the parking space PS in which a power transmission unit 92 having a circular shape in a top view is installed. The vehicle control ECU 201 generates the parking space image 302 from the image data acquired from each of the cameras 210, 211, 212, and 213. As illustrated in FIG. 2A, FIG. 2B, and FIG. 2C, the vehicle control ECU 201 superimposes and displays the external appearance image 305 and a target parking area image 306 on the parking space image 302.

The external appearance image 305 is displayed in order to show the position, dimensions, and shape of the power transmission unit 92 installed in the parking space PS. As described above, the external appearance image 305 of the power transmission unit 92 is registered in association with the identification information on the wireless power supply device 90. When wireless communication to and from the wireless power supply device 90 is established, the vehicle control ECU 201 acquires the identification information on the wireless power supply device 90 from the wireless power supply device 90 by wireless communication, and reads out the external appearance image 305 associated with identification information having the same content as the acquired identification information. In the at least one embodiment, the identification information is information indicating the manufacturer of the wireless power supply device 90, and hence the vehicle control ECU 201 reads out the external appearance image 305 associated with the same manufacturer as the manufacturer indicated by the identification information acquired from the wireless power supply device 90. Then, the vehicle control ECU 201 superimposes and displays the read external appearance image 305 on the parking space image 302.

The vehicle control ECU 201 sets the position of the external appearance image 305 on the parking space image 302 to the position corresponding to the position at which the power transmission unit 92 is installed in the actual parking space PS (the position corresponding to the position identified by the above-mentioned method). Further, the vehicle control ECU 201 sets the orientation of the external appearance image 305 on the parking space image 302 (that is, the orientation of the image of the power transmission unit 92 superimposed and displayed on the parking space image 302) to the same orientation as the orientation of the power transmission unit 92 in the actual parking space PS. For example, when the orientation of the power transmission unit 92 in the parking space PS is determined in advance by the manufacturer, the vehicle control ECU 201 sets the orientation of the external appearance image 305 on the parking space image 302 to the same orientation as the orientation determined in advance. Moreover, the vehicle control ECU 201 sets the ratio of the dimensions of the external appearance image 305 to the dimensions of the parking space PS on the parking space image 302 to the same ratio as the ratio of the dimensions of the power transmission unit 92 to the dimensions of the actual parking space PS. In this way, the vehicle control ECU 201 superimposes and displays the external appearance image 305 on the parking space image 302 so that the external appearance image 305 shows the actual position, dimensions, and orientation of the power transmission unit 92 installed in the parking space PS.

The target parking area image 306 is an image showing the target parking area TA set in the parking space PS. The position and orientation of the target parking area image 306 on the parking space image 302 indicate the position and orientation of the target parking area TA set in the parking space PS. The target parking area image 306 includes an image showing an external shape (for example, contour) of the target parking area TA (hereinafter referred to as “vehicle image 307”) and an image showing the position of the power receiving unit 224 when the vehicle 10 is parked in the target parking area TA (hereinafter referred to as “power receiving unit image 308”). The vehicle image 307 is, for example, an image of a figure having the same shape as the external shape of the vehicle 10 in a top view, or a quadrilateral (rectangle or square) image having the same ratio as the ratio between a front-and-rear dimension and a left-and-right dimension of the vehicle 10 in a top view. The power receiving unit image 308 is an image of a figure having the same shape as the shape of the power receiving unit 224 in a top view. The position, dimensional ratio, and orientation of the power receiving unit image 308 with respect to the vehicle image 307 in the parking space image 302 are the same as the position, dimensional ratio, and orientation of the power receiving unit 224 with respect to the vehicle 10 in a top view. Therefore, it can be said that the position and dimensions of the power receiving unit image 308 with respect to the vehicle image 307 indicates the position and dimensions of the power receiving unit 224 with respect to the vehicle 10.

The target parking area image 306 on the parking space image 302 is initially displayed at a predetermined default position (initial position). In FIG. 2A, the target parking area image 306 displayed at the default position is illustrated. In FIG. 2A, a case in which the position of the power receiving unit image 308 of the target parking area image 306 displayed at the default position is different from the position of the external appearance image 305 of the power transmission unit 92 is illustrated.

The movement button images 303 are images operated by the occupant of the vehicle 10 in order to move the target parking area image 306 on the parking space image 302. The movement button images 303 include, for example, as illustrated in FIG. 2A, a button image showing arrows in respective directions of up, down, left, and right, a button image showing an arrow in a clockwise direction, and a button image showing an arrow in a counterclockwise direction. When the vehicle control ECU 201 detects a touch operation on any of the movement button images 303, the vehicle control ECU 201 moves the target parking area image 306 on the parking space image 302 in the parallel direction or rotational direction indicated by the direction of the arrow of the touched movement button image. Therefore, the position of the power receiving unit image 308 of the target parking area image 306 and the position of the external appearance image 305 of the power transmission unit 92 can be aligned with each other by an operation of touching the movement button images 303.

The confirmation button image 304 is an image operated by the occupant of the vehicle 10 in order to set (confirm) the position and orientation of the target parking area image 306 in the parking space image 302 to the position and orientation of the target parking area TA. When the vehicle control ECU 201 detects a touch operation on the confirmation button image 304 while the setting image 300 is displayed, the vehicle control ECU 201 confirms the position and orientation of the target parking area image 306 with respect to the parking space PS on the parking space image 302 at the time at which the touch operation is detected as the actual position and orientation of the target parking area TA with respect to the parking space PS. Further, when the vehicle control ECU 201 confirms the position and orientation of the target parking area TA, the vehicle control ECU 201 sets a target travel route TR along which the vehicle 10 is to travel in order to park the vehicle 10 in the target parking area TA. The method of setting the target travel route TR is not limited, and a publicly known method can be applied.

When confirmation of the target parking area TA and confirmation of the target travel route TR are complete, the vehicle control ECU 201 waits for an operation by the occupant to instruct movement of the vehicle 10 to be started. When the operation is detected, the vehicle control ECU 201 starts parking travel processing. The parking travel processing is processing of causing the vehicle 10 to travel along the set target travel route TR to the target parking area TA based on, for example, information relating to three-dimensional objects present around the vehicle 10 detected by the sonar sensor 214, images of the peripheral regions of the vehicle 10 taken by each of the cameras 210, 211, 212, and 213, and the vehicle speed acquired from the vehicle speed sensor (not shown). The vehicle control ECU 201 transmits a drive command to the PM ECU 202, a steering command to the EPS ECU 203, a shift change command to the SBW ECU 204, and a braking command to the brake ECU 205 so that the vehicle 10 travels along the target travel route TR to the target parking area TA.

In this way, the external appearance image 305 associated with identification information having the same content as the identification information acquired from the wireless power supply device 90 is superimposed and displayed on the parking space image 302. The external appearance image 305 superimposed and displayed on the parking space image 302 shows the actual shape and dimensions of the power transmission unit 92 installed in the parking space PS. For example, when the power transmission unit 92 is a quadrilateral, as illustrated in FIG. 2A, an external appearance image 305 having a quadrilateral shape is superimposed and displayed on the target parking area image 306. Further, when the power transmission unit 92 is circular, as illustrated in FIG. 2B, an external appearance image 305 having a circular shape is superimposed and displayed on the target parking area image 306.

Therefore, for example, the occupant of the vehicle 10 can recognize the position (relative position with respect to the parking space PS), shape, orientation, and size of the power transmission unit 92 installed in the parking space PS by looking at the parking space image 302 displayed on the touch panel display 209 of the HMI 208. Further, the target parking area image 306 is superimposed and displayed on the parking space image 302. Thus, by looking at the parking space image 302 and the target parking area image 306, for example, the occupant of the vehicle 10 can recognize the positional relationship in a top-view between the power transmission unit 92 installed in the parking space PS and the power receiving unit 224 when the vehicle 10 is parked in the target parking area TA. Moreover, for example, the occupant of the vehicle 10 can set the target parking area TA to the “position suitable for charging” by moving the target parking area image 306 so that the position of the external appearance image 305 and the position of the power receiving unit image 308 match each other on the parking space image 302. At this time, for example, the occupant of the vehicle 10 can set the position and orientation of the target parking area

TA while recognizing the positional relationship between the power transmission unit 92 and the power receiving unit 224 by looking at the parking space image 302 displayed on the touch panel display 209 of the HMI 208. Therefore, it becomes easier to set the target parking area TA to the “position suitable for charging.”

The occupant (user) of the vehicle 10 can align the installation position of the power transmission unit 92 installed in the parking space PS and the position of the power receiving unit 224 of the vehicle parked in the target parking area TA by moving the target parking area image 306 in the parking space image 302 displayed on the touch panel display 209 of the HMI 208. In this case, the occupant of the vehicle 10 can easily move the target parking area image 306 by operating (touching) the movement button images 303 displayed on the touch panel display 209 of the HMI 208.

In addition, according to the at least one embodiment, the vehicle control ECU 201 reads out the external appearance image 305 associated with identification information having the same content as the identification information acquired from the wireless power supply device 90, and displays the read external appearance image 305. With such a configuration, even when the dimensions and shape of the power transmission unit 92 are different for each parking space PS, an external appearance image 305 showing the dimensions and shape of the power transmission unit 92 actually installed in the parking space PS can be displayed. Therefore, the occupant of the vehicle 10 can set the position and orientation of the target parking area TA so that the occupant can park the vehicle 10 in a “position suitable for charging the vehicle 10” in accordance with the shape and dimensions of the power transmission unit 92 installed in the parking space PS in which the vehicle 10 is to be parked. Further, in the at least one embodiment, information indicating the manufacturer of the wireless power supply device 90 is used as the identification information. Therefore, even when the dimensions and shape of the power transmission units 92 are different for each manufacturer, an external appearance image 305 showing the dimensions and shape of the power transmission unit 92 actually installed in the parking space PS can be displayed.

(Operation of Parking Assist Apparatus)

Next, operation of the assist apparatus 20 is described. Each of the cameras 210, 211, 212, and 213 continuously executes processing of “generating image data by photographing the landscape of the peripheral region of the vehicle 10, and transmitting the generated image data to the vehicle control ECU 201.” The vehicle control ECU 201 continuously executes processing of extracting a plurality of feature points from the image data acquired from each of the cameras 210, 211, 212, and 213.

The communication ECU 206 continuously searches for a wireless power supply device 90 (equipment communication device 91) capable of wireless communication by using the first communication method. When the communication ECU 206 detects a wireless power supply device 90 capable of wireless communication, the communication ECU 206 establishes wireless communication based on the first communication method between the in-vehicle communication device 223 and the equipment communication device 91 of the wireless power supply device 90. When the in-vehicle communication device 223 includes a communication circuit compliant with a wireless LAN standard such as the Institute of Electrical and Electronic Engineers (IEEE) 802.11 series, the communication ECU 206 continuously wirelessly transmits an authentication signal to the in-vehicle communication device 223. The communication ECU 206 then waits for the in-vehicle communication device 223 to receive an authentication signal transmitted by the equipment communication device 91. When the in-vehicle communication device 223 receives the authentication signal transmitted by the equipment communication device 91, the vehicle control ECU 201 causes the in-vehicle communication device 223 to transmit a connection request, and waits for a connection permission signal to be transmitted from the equipment communication device 91. When the in-vehicle communication device 223 receives the connection permission signal transmitted from the equipment communication device 91, the vehicle control ECU 201 establishes wireless communication to and from the equipment communication device 91. When wireless communication is established between the in-vehicle communication device 223 and the equipment communication device 91, the vehicle control ECU 201 acquires the identification information on the wireless power supply device 90 from the wireless power supply device 90 by wireless communication.

The vehicle control ECU 201 may execute the processing of extracting the feature points when a predetermined condition is satisfied. Similarly, the communication ECU 206 may execute the processing for establishing wireless communication between the in-vehicle communication device 223 and the equipment communication device 91 when a predetermined condition is satisfied. For example, when the vehicle speed becomes equal to or lower than a threshold value while the vehicle 10 is traveling, the vehicle control ECU 201 determines that the predetermined condition is satisfied, starts executing the processing of extracting the plurality of feature points from the image data acquired from each of the cameras 210, 211, 212, and 213, and starts searching for a wireless power supply device 90 capable of wireless communication to and from the communication ECU 206.

After the vehicle 10 stops, when the vehicle control ECU 201 detects an operation on the parking assist switch 215, the vehicle control ECU 201 searches for a parking space PS which is present in the peripheral region of the vehicle 10 and has a wireless power supply device 90 capable of wireless communication installed therein. When the vehicle control ECU 201 has successfully recognized a parking space PS, the vehicle control ECU 201 identifies the position of the parking space PS on the real coordinate system. The vehicle control ECU 201 reads out the identification information associated with the manufacturer indicated by the manufacturer information acquired from the wireless power supply device 90 via wireless communication, uses the read identification information to recognize the power transmission unit 92 installed in the parking space PS, and identifies the position of the recognized power transmission unit 92.

The vehicle control ECU 201 displays the setting image 300 on the touch panel display 209 of the HMI 208. At this time, the vehicle control ECU 201 reads out the external appearance data associated with the same manufacturer as the manufacturer indicated by the identification information acquired via wireless communication, and superimposes and displays the external appearance image 305 of the power transmission unit 92 included in the read external appearance data on the parking space image 302 of the setting image 300. Together with this, the vehicle control ECU 201 superimposes and displays the target parking area image 306 on the parking space image 302 of the setting image 300. When the vehicle control ECU 201 detects an operation for moving the target parking area image 306 (a touch operation on the movement button images 303), the vehicle control ECU 201 moves the target parking area image 306 on the parking space image 302 in accordance with the operation. When the vehicle control ECU 201 has failed to detect a parking space PS in which the vehicle 10 can be parked, in place of the setting image 300, the vehicle control ECU 201 displays an image notifying that a parking space PS in which the vehicle 10 can be parked is not present on the touch panel display 209 of the HMI 208.

When the vehicle control ECU 201 detects a touch operation on the confirmation button image 304 while the setting image 300 is displayed, the vehicle control ECU 201 confirms the position and orientation of the target parking area image 306 displayed on the parking space image 302 as the actual position and orientation of the target parking area TA with respect to the parking space PS. Further, when the vehicle control ECU 201 confirms the position and orientation of the target parking area TA, the vehicle control ECU 201 sets a target travel route TR along which the vehicle 10 is to travel in order to park the vehicle 10 in the target parking area TA. The method of setting the target travel route TR is not limited, and a publicly known method can be applied.

When confirmation of the target parking area TA and confirmation of the target travel route TR are complete, the vehicle control ECU 201 waits for an operation by the occupant to instruct movement of the vehicle 10 to be started. For example, the vehicle control ECU 201 displays a parking start button image on the touch panel display 209 of the HMI 208. Then, when the vehicle control ECU 201 detects a touch operation on the parking start button image, the vehicle control ECU 201 starts the parking travel processing.

The vehicle control ECU 201 stops the vehicle 10 and ends the parking travel processing when the entire vehicle 10 is contained within the target parking area TA by the execution of the parking travel processing. As a result, parking of vehicle 10 in the target parking area TA is complete.

The communication ECU 206 uses, during the execution of the parking travel processing, another communication method different from the first communication method (the another communication method is hereinafter referred to as “second communication method”) to establish wireless communication between the in-vehicle communication device 223 and the wireless power supply device 90 (equipment communication device 91). As the second communication method, a method having a shorter wireless communication distance than that of the first communication method is applied. For example, a communication method compliant with a wireless PAN standard such as the IEEE 802.15 series can be applied as the second communication method. The second communication method may be a communication method based on the wireless LAN standard, a DSRC method, or an RFID method. When the parking is complete, the vehicle control ECU 201 transmits a signal instructing charging to be started to the communication ECU 206. When the communication ECU 206 receives the signal instructing charging to be started from the vehicle control ECU 201, the communication ECU 206 controls the in-vehicle communication device 223. The in-vehicle communication device 223 transmits, under the control of the communication ECU 206, the “signal instructing charging to be started” to the equipment communication device 91 by wireless communication based on the second communication method. When the wireless power supply device 90 receives the signal by the equipment communication device 91, the wireless power supply device 90 starts power transmission. As a result, the power receiving unit 224 receives power. The power received by the power receiving unit 224 is charged in the battery 11.

After that, the vehicle control ECU 201 continuously acquires information indicating a charging rate of the battery 11 from the charging ECU 207, and continuously determines whether or not the charging rate of the battery 11 becomes equal to or higher than a predetermined threshold value. When the charging rate of the battery 11 becomes equal to or higher than the predetermined threshold value, the vehicle control ECU 201 transmits a signal instructing charging to be ended to the communication ECU 206. When the communication ECU 206 receives the signal instructing charging to be ended from the vehicle control ECU 201, the communication ECU 206 controls the in-vehicle communication device 223. The in-vehicle communication device 223 transmits, under the control of the communication ECU 206, the “signal instructing charging to be ended” to the equipment communication device 91 by wireless communication based on the second communication method. When the equipment communication device 91 receives the signal, the wireless power supply device 90 stops (ends) power transmission. As a result, charging of the battery 11 ends. The wireless power supply device 90 may acquire information indicating the charging rate of the battery 11 of the vehicle 10 by wireless communication, and stop power transmission based on the acquired information indicating the charging rate.

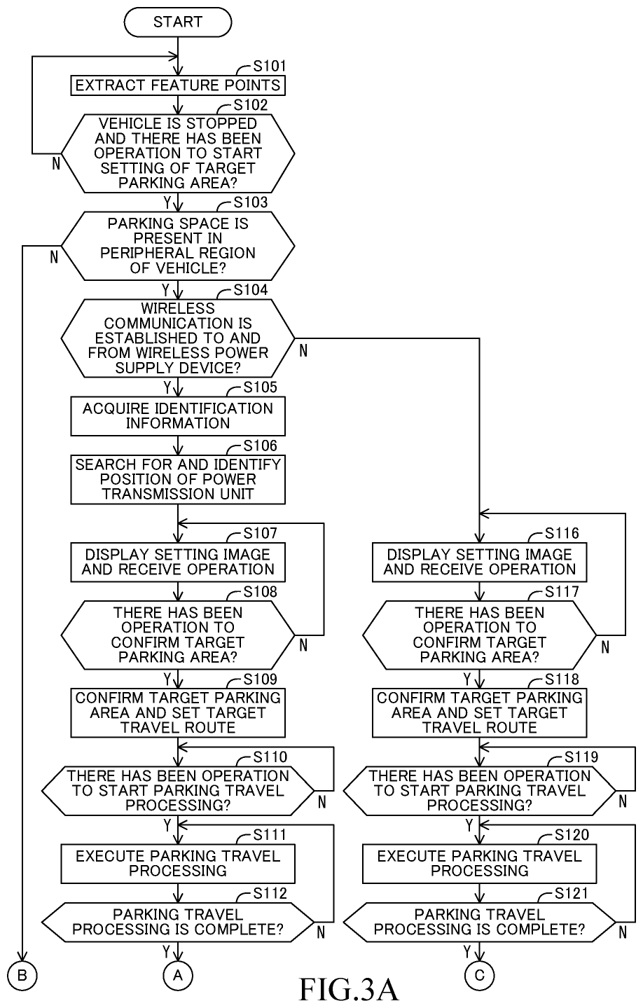

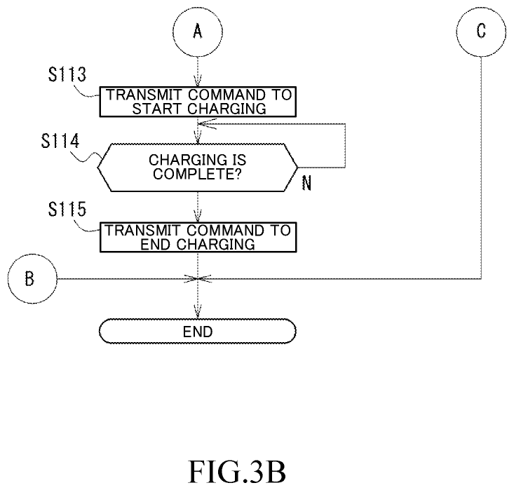

Next, a parking assist routine to be executed by the CPU of the vehicle control ECU 201 is described with reference to FIG. 3A and FIG. 3B. FIG. 3A and FIG. 3B are flow charts for illustrating a parking assist routine to be executed by the CPU of the vehicle control ECU 201. The routine is executed when a predetermined condition is satisfied, for example, when the vehicle speed is equal to or lower than a predetermined vehicle speed. In the following description, the CPU of the vehicle control ECU 201 is simply referred to as “CPU.” In the readable/writable non-volatile memory of the vehicle control ECU 201, the external appearance data of the power transmission unit 92 of each of a plurality of wireless power supply devices 90 is stored in advance in association with identification information on the wireless power supply device 90. Each of the cameras 210, 211, 212, and 213 continuously executes processing of “generating image data by photographing the landscape of the peripheral region of the vehicle 10, and transmitting the generated image data to the vehicle control ECU 201.” Further, during the period in which wireless communication based on the first communication method is not established between the in-vehicle communication device 223 and the equipment communication device 91, the communication ECU 206 continues to search for a wireless power supply device 90 capable of communication by wireless communication based on the first communication method. When the communication ECU 206 detects a wireless power supply device 90 capable of wireless communication, the communication ECU 206 establishes wireless communication based on the first communication method to and from the wireless power supply device 90 (equipment communication device 91).

In Step S101, the CPU acquires image data from each of the cameras 210, 211, 212, and 213, extracts a plurality of feature points from the acquired image data, and stores feature point information on the extracted feature points in the RAM in association with ID information for identifying each feature point. Then, the CPU advances the process to Step S102.

In Step S102, the CPU determines whether or not the vehicle 10 is stopped and there has been an operation to start the setting of the target parking area TA. In the at least one embodiment, the CPU determines that there has been an operation to start the setting of the target parking area TA when there has been an operation on the parking assist switch 215. When the vehicle 10 is stopped and there has been an operation to start the setting of the target parking area TA, the CPU advances the process to Step S103. When there has not been an operation to start the setting of the target parking area TA, the CPU returns the process to Step S101. Further, in a case in which the vehicle 10 is traveling, the CPU returns the process to Step S101 without advancing the process to Step S103 even when there has been an operation to start the setting of the target parking area TA.

In Step S103, the CPU uses the feature points extracted in Step S101 to search for a parking space PS present in the peripheral region of the vehicle 10 in which the vehicle 10 can park. Then, the CPU determines whether or not a parking space PS present in the peripheral region of the vehicle 10 in which the vehicle 10 can park has successfully been detected (recognized). When a parking space PS present in the peripheral region of the vehicle 10 in which the vehicle 10 can park has successfully been detected (in other words, when the parking space PS is present), the CPU advances the process to Step S104. When a parking space PS present in the peripheral region of the vehicle 10 in which the vehicle 10 can park has failed to be detected, the CPU ends this parking assist routine.

In Step S104, the CPU determines whether or not wireless communication based on the first communication method is established between the in-vehicle communication device 223 and the equipment communication device 91. When wireless communication based on the first communication method is established between the in-vehicle communication device 223 and the equipment communication device 91, the CPU advances the process to Step S105. Meanwhile, when wireless communication is not established between the in-vehicle communication device 223 and the equipment communication device 91, the CPU advances the process to Step S116.

In Step S105, the CPU acquires the identification information on the wireless power supply device 90 via wireless communication from the wireless power supply device 90 for which wireless communication has been established. Then, the CPU advances the process to Step S106.

In Step S106, the CPU searches for the power transmission unit 92 installed in the parking space PS by using the feature point information extracted in Step S101, and when the power transmission unit 92 has successfully been detected (recognized), identifies the position of the power transmission unit 92. Then, the CPU advances the process to Step S107.

In Step S107, the CPU displays the setting image 300 on the touch panel display 209 of the HMI 208. As described above, the setting image 300 includes the parking space image 302, the movement button images 303, and the confirmation button image 304. The CPU reads out the external appearance image 305 associated with the same manufacturer as the manufacturer indicated by the identification information acquired in Step S105 from the readable/writable non-volatile memory, and displays the read external appearance image 305 at the position corresponding to the position identified in Step S106 on the parking space image 302. Further, the CPU superimposes and displays the target parking area image 306 on the parking space image 302. The position of the target parking area image 306 immediately after the display of the setting image 300 is started may be the default position.

The CPU then receives touch operations on the movement button images 303 and the confirmation button image 304 during the period in which the setting image 300 is displayed on the touch panel display 209 of the HMI 208. Specifically, when the CPU detects a touch operation on the movement button images 303, the CPU moves the target parking area image 306 in accordance with the touch operation. Then, the CPU advances the process to Step S108.

In Step S108, the CPU determines whether or not there has been a touch operation on the confirmation button image 304. When there has been a touch operation, the CPU advances the process to Step S109. When there has not been a touch operation, the CPU returns the process to Step S107.

In Step S109, the CPU confirms the “position and orientation of the target parking area image 306 on the parking space image 302” at the time at which the touch operation on the confirmation button image 304 is detected in Step S108 as the actual position and orientation of the target parking area TA in the parking space PS. Then, the CPU sets the target travel route TR for the vehicle 10 to travel along in order to park the vehicle 10 in the target parking area TA. Then, the CPU advances the process to Step S110.

In Step S110, the CPU determines whether or not there has been an operation to instruct the parking travel processing to be started. When an operation to instruct the parking travel processing to be started is detected, the CPU advances the process to Step 5111. For example, when the CPU detects a touch operation on the “confirmation button image 304,” the CPU displays the “parking start button image” on the touch panel display 209 of the HMI 208. Then, when the CPU detects a touch operation on the parking start button image, the CPU determines that there has been an operation to instruct the parking travel processing to be started. When there has not been an operation to instruct the parking travel processing to be started, the CPU causes the process to wait at this step, and when the operation is performed, advances the process to Step S111.

In Step S111, the CPU executes the parking travel processing. Further, after execution of the parking travel processing is started, the CPU transmits a command to establish wireless communication based on the second communication method between the in-vehicle communication device 223 and the equipment communication device 91 to the communication ECU 206. When the communication ECU 206 receives the command, the communication ECU 206 establishes wireless communication based on the second communication method between the in-vehicle communication device 223 and the equipment communication device 91. Then, the CPU advances the process to Step S112. In Step S112, the CPU determines whether or not the parking travel processing is complete, specifically, whether or not the vehicle 10 has reached the target parking position and stopped. When the parking travel processing is not complete, the CPU continues to execute the parking travel processing until the vehicle 10 reaches the target parking position and stops. When the parking travel processing is complete, the CPU advances the process to Step S113.

In Step S113, the CPU transmits a signal instructing charging to be started to the communication ECU 206. When the communication ECU 206 receives the signal instructing charging to be started from the vehicle control ECU 201, the communication ECU 206 causes the in-vehicle communication device 223 to transmit the “signal instructing charging to be started” to the equipment communication device 91 by wireless communication based on the second communication method. As a result, power transmission by the wireless power supply device 90 is started. The power transmitted from the wireless power supply device 90 is received by the power receiving unit 224, and the power received by the power receiving unit 224 is charged in the battery 11. Then, the CPU advances the process to Step S114.

In Step S114, the CPU determines whether or not charging is complete. Specifically, the CPU continuously acquires information indicating the charging rate of the battery 11 from the charging ECU 207, and determines whether or not the charging rate of the battery 11 becomes equal to or higher than a predetermined threshold value. When the charging rate of the battery 11 becomes equal to or higher than the predetermined threshold value, the CPU determines that the charging is complete. The CPU causes the process to wait at this step until the charging of the battery 11 is complete, and when the charging is complete, advances the process to Step S115.

In Step S115, the CPU transmits a signal instructing charging to be ended to the communication ECU 206. When the communication ECU 206 receives the signal instructing charging to be ended from the vehicle control ECU 201, the communication ECU 206 causes the in-vehicle communication device 223 to transmit the “signal instructing charging to be ended” to the equipment communication device 91 by wireless communication based on the second communication method. As a result, power transmission by the wireless power supply device 90 is stopped (ended). The wireless power supply device 90 may acquire information indicating the charging rate of the battery 11 of the vehicle 10 by wireless communication, and stop power transmission based on the acquired information indicating the charging rate. In this case, the processing steps of Step S114 and Step S115 are not required.

When wireless communication to and from the wireless power supply device 90 based on the first communication method has failed to be established in Step S104, the CPU advances the process to Step S116. In this case, a power transmission unit 92 of the wireless power supply device 90 is not installed in the parking space PS. The steps of from Step S116 to Step S121 are the same as the steps of from Step S107 to Step S112, respectively, except that the control for establishing wireless communication based on the second communication method is not executed in Step S120.

The above-mentioned parking assist control is implemented based on such a parking assist routine.

Description has been given of the at least one embodiment of the present invention, but the present invention is not limited to the at least one embodiment described above. The present invention may adopt various modification examples without departing from the spirit of the present invention.

For example, in the at least one embodiment described above, there has been described the configuration in which the power receiving unit 224 includes the power receiving coil 225 and can receive the transmission of power from the power transmission unit 92 of the wireless power supply device 90 in a non-contact manner. However, the power receiving unit 224 is not limited to such a configuration. Specifically, the power receiving unit 224 may have a configuration capable of receiving the transmission of power by contacting the power receiving unit 224 with a power transmission unit of a contact-type power supply device. For example, there has been known a contact-type power supply device including a power transmission unit configured to contact the power receiving unit 224 arranged in the vehicle 10 by ascending. The power receiving unit 224 of the assist apparatus 20 according to the at least one embodiment of the present invention may be configured to be able to receive the transmission of power by contacting the power transmission unit of such a contact-type power supply device. In order for the power transmission unit of a contact-type power supply device to contact the power receiving unit 224 installed in the vehicle 10 so as to be able to transmit power, the power receiving unit 224 installed in the vehicle 10 and the power transmission unit installed in the parking space PS are required to be aligned. According to the at least one embodiment of the present invention, various types of power transmission units having different external appearances can be recognized, and hence a target parking area TA can be set in a position suitable for charging for each parking space PS in which a power transmission unit of a contact-type power supply device having a different external appearance is installed.

Further, in the at least one embodiment described above, there has been described the configuration in which the in-vehicle communication device 223 and the equipment communication device 91 can wirelessly communicate to and from each other based on the first communication method and the second communication method which are different from each other, and the in-vehicle communication device 223 acquires identification information from the wireless power supply device 90 by wireless communication based on the first communication method and transmits a signal instructing charging to be started or charging to be ended to the wireless power supply device 90 by wireless communication based on the second communication method. However, the present invention is not limited to such a configuration. For example, the communication method for wireless communication to be used when the in-vehicle communication device 223 acquires the identification information from the equipment communication device 91 may be the same communication method as the communication method for wireless communication to be used when the in-vehicle communication device 223 transmits a signal instructing charging to be started or charging to be ended to the equipment communication device 91. The specific methods of the first communication method and the second communication method are not particularly limited, and related-art publicly known communication methods (communication standards) can be applied.

Further, in the at least one embodiment described above, as the parking assist control, control of parking the vehicle 10 in the target parking area TA without requiring the driver to operate the accelerator pedal, the brake pedal, or the steering wheel has been described. However, the parking assist control is not limited to such control. For example, the parking assist control may be control performed by controlling the steering angle of the steered wheels of the vehicle 10 so that the vehicle 10 travels along the target travel route TR and causing the vehicle 10 to travel in accordance with the operation of the accelerator pedal and the shift operation by the occupant of the vehicle 10. In short, the parking assist control may be any control of assisting the parking of the vehicle 10 in the target parking area TA.

Further, the external appearance image 305 is not limited to an image obtained by photographing the power transmission unit 92 from vertically above. For example, the external appearance image 305 may be an image of a figure having the same shape as the shape of the power transmission unit 92 in a top view.

Moreover, related-art publicly known methods and processing can be applied to the method of setting the target travel route TR and the parking travel processing. Similarly, a related-art publicly known method can be applied to the method of identifying the position in the real coordinate system from the position of the image of the power transmission unit 92 included in the image data acquired from each of the cameras 210, 211, 212, and 213 (in other words, the coordinate conversion method).

What is claimed is:

1. A parking assist apparatus,
the parking assist apparatus being mounted on a vehicle including a power receiving unit configured to receive power from a power supply device including a power transmission unit,
the parking assist apparatus being configured to execute parking assist for parking the vehicle in a parking space,
the parking assist apparatus comprising:
a wireless communication device configured to perform wireless communication to and from the power supply device;
an image pickup device configured to photograph a peripheral region of the vehicle;
a display device configured to display an image taken by the image pickup device; and
a control device configured to search for a parking space present in the peripheral region of the vehicle from the image of the peripheral region of the vehicle taken by the image pickup device, set a target parking area in the parking space detected by the search, and assist parking of the vehicle in the target parking area,
the control device having an external appearance image showing an external appearance of each of a plurality of the power transmission units registered therein in association with identification information on the power supply device,
the control device being configured to:
display a parking space image showing the detected parking space on the display device;
superimpose and display, on the parking space image, a target parking area image showing a target parking area of the vehicle with respect to the parking space and a position of the power receiving unit when the vehicle is parked in the target parking area;
identify an installation position of the power transmission unit in the parking space based on the image taken by the image pickup device;
acquire the identification information from the power supply device via the wireless communication device; and
superimpose and display the external appearance image associated with the identification information acquired from the power supply device on a position corresponding to the installation position in the parking space image displayed on the display device.

2. The parking assist apparatus according to claim 1, wherein the control device is configured to control display of the target parking area image so that the target parking area image displayed on the display device is movable.

3. The parking assist apparatus according to claim 2, wherein the control device is configured to display, on the display device, a movement button image for moving the target parking area image.

4. The parking assist apparatus according to claim 1, wherein the identification information is information indicating a manufacturer of the power supply device.

5. The parking assist apparatus according to claim 1, wherein the power receiving unit includes a power receiving coil configured to receive transmission of power in a non-contact manner from the power transmission unit including a power transmission coil.

6. The parking assist apparatus according to claim 1, wherein the control device is configured to:
display a confirmation button image for confirming a position of the target parking area image on the display device; and
move the vehicle to the target parking area when the confirmation button image is operated.
